(19) United States
(12) Patent Application Publication
(10) Pub. No.: US 2018/0313744 A1
(43) Pub. Date: Nov. 1, 2018

(54) System and Process for Corrosion Monitoring

(71) Applicant: Intelliconnect, LLC, Plano, TX (US)

(72) Inventors: George Thomas Hazelton, JR., Plano, TX (US); Yehyun Choi, Dallas, TX (US); Woochan Kim, Dallas, TX (US); Daewook Kwon, Dallas, TX (US); Tae-Hyeon Kim, Dallas, TX (US)

(21) Appl. No.: 15/955,765

(22) Filed: Apr. 18, 2018

Related U.S. Application Data
(60) Provisional application No. 62/491,144, filed on Apr. 27, 2017.

(51) Int. Cl. G01N 17/02; G01N 17/04; G01N 17/00

(52) U.S. Cl. CPC G01N 17/02; G01N 17/006; G01N 17/04

(57) ABSTRACT

The present invention is directed to system and process for corrosion monitoring. An embodiment of a system includes a conductor, an electrical connector, a sensor system, a transmitter, a network, and a computer having a database. The conductor is one or more current carrying conductors inline with and having a connector at each end such that there is electrical communication from connector to connector. The sensor system is configured for attachment to the conductor, and is operable to measure one or more of resistance, temperature, current flow, surrounding radio frequency and/or magnetic flux. The transmitter coupled the sensor system, operable to transmit data from the sensor system over a network to a processor for further processing. The computer includes a database for storage of sensor system in the form of instantaneous values, average values, a series of values, vectors representing values, or waveforms.

In usage, threshold sensor system values are established and the electronic equipment having the current carrying conductors is deployed. Sensor systems are coupled to the current carrying conductors, which are monitored for one or more of resistance, temperature, current flow, surrounding radio frequency and/or magnetic flux. The sensor system data is compared to the baseline and when out of threshold, an alert is generated for further inspection.

### BACKGROUND

### FIELD OF THE INVENTION

The present invention relates to corrosion detection and, more particularly, to corrosion monitoring.

### DESCRIPTION OF THE RELATED ART

Significant material and maintenance costs on military as well as commercial products are often attributed to the severity of the environment in which they operate. Ships and aircraft which operate in a maritime environment are particularly susceptible to corrosion. Corrosion damage of aircraft, piers, runways, underground conduits and other items within the military structure can be detrimental. The items themselves or the electronics therein suffer reduced lifecycles, degraded performance, increased failure rates.

Corrosion in wiring can lead to malfunctioning devices, short circuits, and even electrical fires. It is advantageous to detect corrosion issues before any particular issue becomes significant. Current corrosion inspections may not facilitate condition-based maintenance as current sensors may be of limited value, may not correlate well to actual corrosion conditions, and may not detect specific types of corrosion damage typical to the items' environments. Currently, the norm is to manually inspect the items. An inspector travels onsite to the location of the item and visually inspects it, or perhaps also uses a probe to aid in inspection. This leads to gaps in time in inspections and poor selection of items to target for inspection.

### SUMMARY

The present invention is directed to system and process for corrosion monitoring. An embodiment of a system includes a conductor, an electrical connector, a sensor system, a transmitter, a network, and a computer having a database. The conductor is one or more current carrying conductor such as wire inline with and having a connector at each end such that there is electrical communication from connector to connector. The sensor system is configured for attachment to the conductor, and is operable to measure one or more of resistance, temperature, current flow, surrounding radio frequency and/or magnetic flux. The transmitter coupled the sensor system, operable to transmit data from the sensor system over a network to a processor for further processing. The computer includes a database for storage of sensor system in the form of instantaneous values, average values, a series of values, vectors representing values, or waveforms.

In usage, threshold sensor system values are established and the electronic equipment having the current carrying conductor is deployed. Sensor systems are coupled to the current carrying conductors, which are monitored for one or more of resistance, temperature, current flow, surrounding radio frequency and/or magnetic flux. The sensor system data is compared to the baseline and when out of threshold, an alert is generated for further inspection.

These and other features, aspects, and advantages of the invention will become better understood with reference to the following description, and accompanying drawings.

### BRIEF DESCRIPTION OF THE DRAWINGS

FIG. 1 depicts a block diagram of major components of a system for an embodiment of the current invention;

FIGS. 2A-2B depict representative connectors;

FIGS. 3A-3E depict representative sensors; and

FIGS. 4A-4B depict representative waveforms and charts;

FIG. 5 depict an embodiment of a process of the current invention.

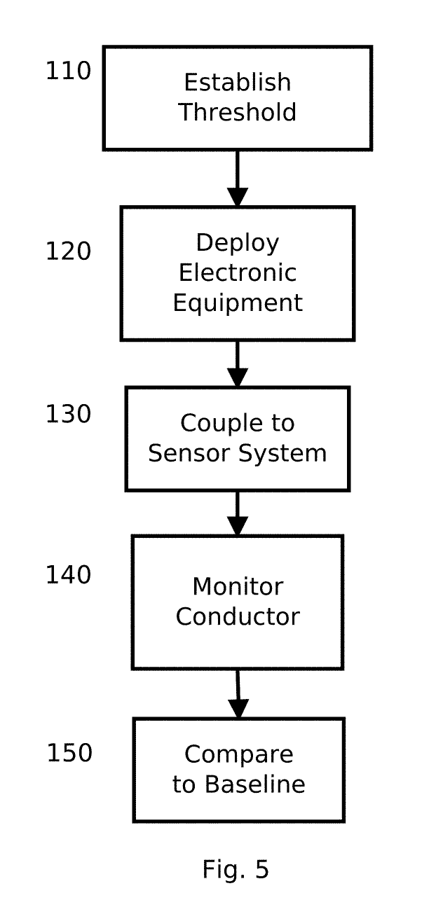

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

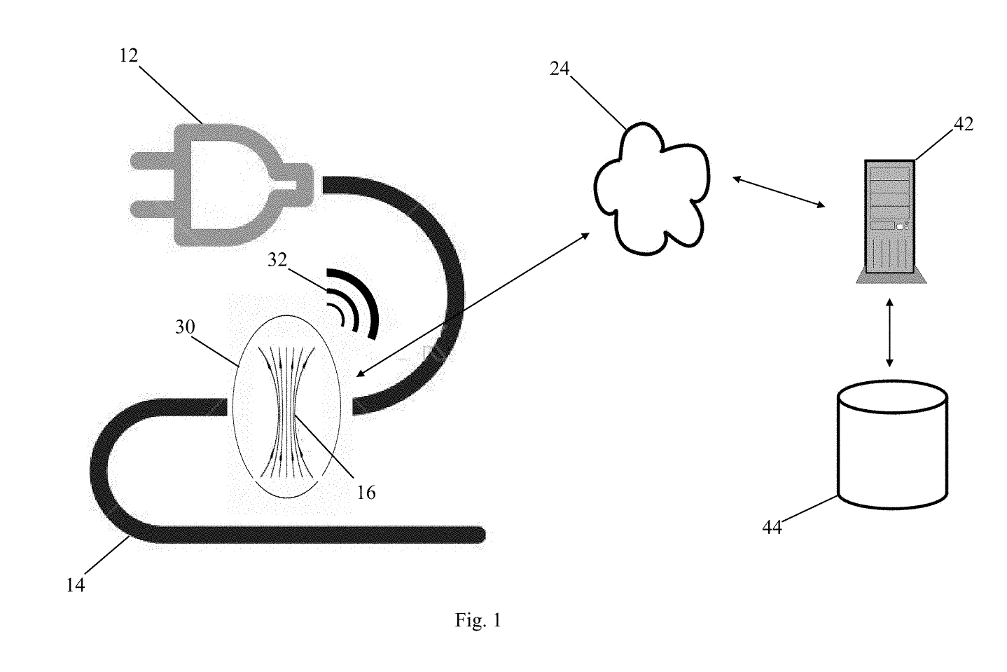

The present invention is directed to systems and processes for corrosion monitoring. FIG. 1 illustrates an embodiment of a system according to the present invention as it may exist in operation. Depicted are a conductor 14, an electrical connector 12, a sensor system 30, a network 24, and a computer 42 having a database 44.

The illustrated conductor 14 is an electrical wire 14 composed of conductive material, such as copper. The wire 14 is an electrical conductor used in power generation, power transmission, power distribution, telecommunications, electronics circuitry, and electrical equipment. Copper and its alloys are commonly used to make electrical contacts. When current is carried by the wire 14, it has a certain resistance, current flow, surrounding radio frequency and magnetic flux 16, and other properties. The values can be constant, periodic, aperiodic, simple or complex.

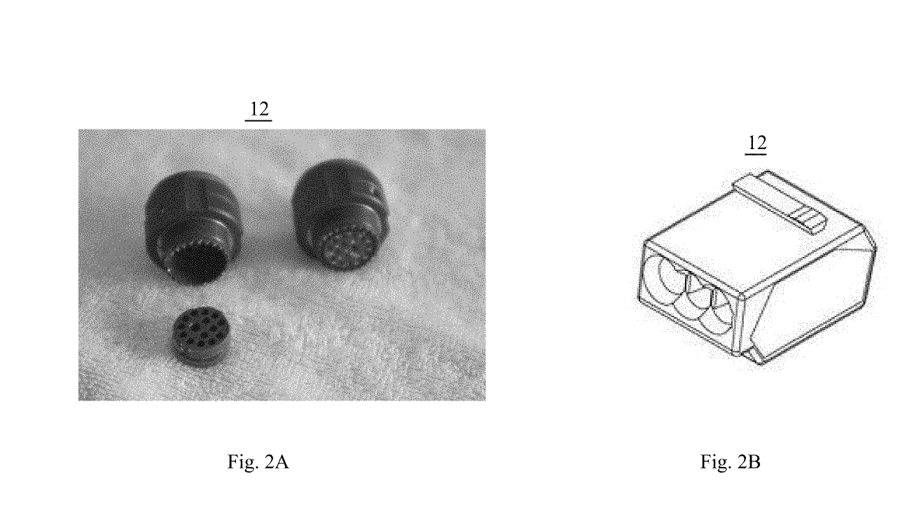

Certain embodiments of the invention include one or connectors 12. FIGS. 2A and 2B illustrates representative connectors. The electrical connector 12 is a device for electrically, communicatively coupling. The electrical connector 12 includes a body having one or more inlets on a face defining a connector region, a cable outlet, a void interior region,. One or more electrical wires 14 extend from a side of the electrical connector 12. Electrical wires 14 may include positive, negative, ground, signal, and other wires. Cable may house the wires and enter the body through a cable inlet. The connector face may take a variety of cross-sectional profiles, pinouts, and other configurations. The connector 12 may have seals, fingers for locking and unlocking, ridges for better interconnection, and other configurations.

Certain configurations of the connector 12 use MIL-DTL D38999 (FIG. 2A) and other military cylindrical connectors to inter-connect power, signal, RF, and grounding between systems. The D38999 conductors 14 are in close proximity to one another. Military cylindrical connectors feature a rear rubber gourmet that supports electrical contacts inserted into the rear of the connector. These electrical contacts (M39029) come is various diameters according to their current carrying capability. For example, a size 20 contact is rated for 5 Amps, whereas a size 16 contact is rated for 10 amps. The connector show below is a D38999/26 style plug and includes accommodation for one 16 AWG contact and fourteen 20 AWG contacts.

Corrosion at the connector 12 or wire 14 sometimes occurs. Corrosion is a process which chemically converts a refined metal conductor to a different form, such as its oxide. It is the gradual destruction of materials by chemical and/or electrochemical reactions with their environment. Commonly, this means electrochemical oxidation of metal in reaction with an oxidant in the air such as oxygen.

Many compositions corrode from exposure to moisture in air, but the process can be strongly affected by exposure to certain substances such as salt (NaCl) water or salt fog. Corrosion can be pervasive on electronics on ships, aircraft, and other equipment used in sea water maritime service. Atmospheric corrosion of metals exposed on or near coastlines, and hot salt corrosion in engines operating at sea or taking in salt-laden air are problematical.

Sometimes, mechanical action can cause or exacerbate the corrosion. It can occur at electrical terminals, result from the improper tightening of the lugs or screws fastening the conductive wire 14 or connectors 12.

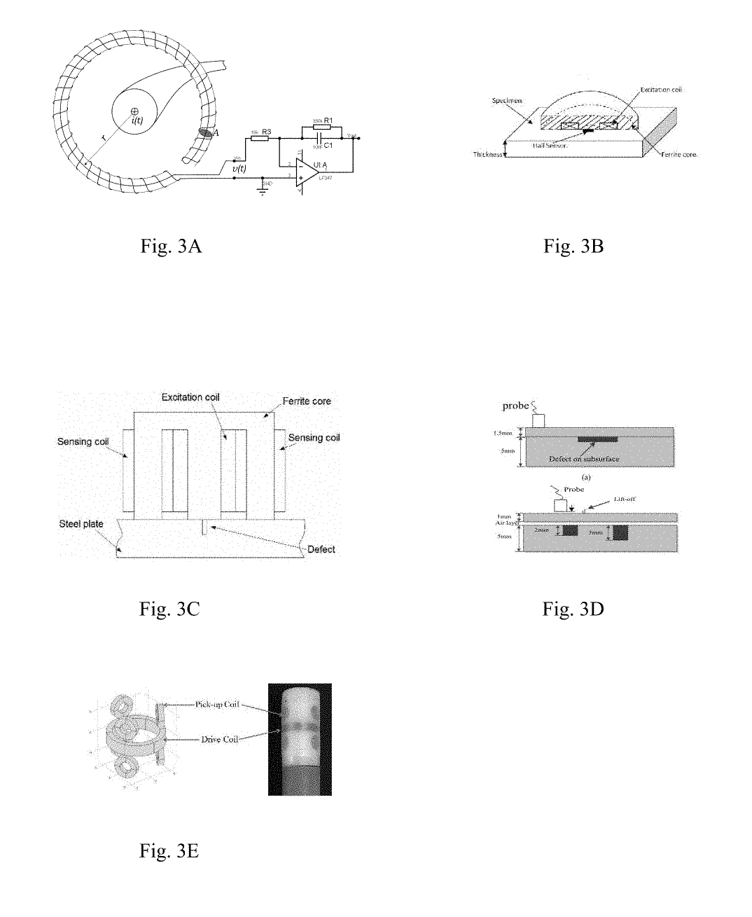

Corrosion normally begins on directly exposed surfaces. Corrosion is the unwanted breakdown and weakening of the material. Corrosion degradation can be concentrated locally to form a pit or crack (see surface of FIG. 3C), or it can extend across a wide area more or less uniformly corroding the exposed surface (see surface of FIG. 3D).

As mentioned, when current is carried by the wire 14, it has a certain resistance, temperature, current flow, surrounding radio frequency and magnetic flux 16, and other properties. The values can be constant, periodic, aperiodic, simple or complex. Corrosion can cause voltage and current flow degradation. As mentioned, corrosion can alter the resistance, temperature, voltage, current flow, surrounding radio frequency and magnetic flux 16, and/or other properties. Corrosion can alter resistance (leading to heat generation), arcing and sparking (leading to current or voltage spikes).

Certain embodiments of the invention includes sensor system 30 attached to the conductor 14, operable to measure one or more of resistance, temperature, current flow, surrounding radio frequency and magnetic flux 16, and other properties of the conductor 14 to which it is attached. The measurements can be instantaneous, periodic, or ongoing. The sensor system 30 outputs a value or values for determining the target property. A fastener may be included in the sensor system 30 in order to secure it to the conductor 14 and maintain its position relative to the conductor 14.

In certain configurations, the employed sensor system 30 is a Rogowski coil system (FIG. 3A), which measures alternating current or high speed current pulses. It consists of a helical coil of wire with the lead from one end returning through the center of the coil to the other end, so that both terminals are at the same end of the coil. The whole assembly is then wrapped around the straight conductor whose current is to be measured. The winding density, the diameter of the coil and the rigidity of the winding is configured to optimize immunity to external fields and positioned for optimum sensitivity of the measured conductor 14. The output of the Rogowski coil is usually connected to a signal processors to provide an output signal that is proportional to the current. Additionally disclosure for Rogowski coil systems is included in the appendix.

In certain configurations, the employed sensor system 30 is a Hall effect sensor system (FIG. 3B, 3C)., which measures magnetic flux 16. A Hall effect sensor is a transducer that varies its output voltage in response to a magnetic field. The Hall sensor includes semiconductor material, such as gallium arsenide or indium arsenide. A current is passed through the semiconductor material which, when placed in a magnetic field has a “Hall effect” voltage developed across it. The Hall effect is seen when a conductor is passed through a uniform magnetic field. The result is seen as a charge separation, with a buildup of either positive or negative charges on the bottom or on the top of the plate, providing a measured output. Again, the Hall sensor system may include signal processors to provide driving current to the sensors, amplify/pre-process the output signal, coefficient corrections, error adjustment and the like. In exemplary usage, the Hall effect sensor system is secured so that the magnetic field lines are passing at right angles through the sensor of the probe, in order to get optimum magnetic flux density values. Additionally disclosure for Hall effect and other sensor systems is included in the appendix.

Other sensor systems 30 can be employed to determine the target property. For example, fluxgate magnetometers sensors, magnetoresistance-based sensors, or other sensors may be employed. Further, the above sensor systems 30 may be used individually or in combination.

In certain configurations, the system 10 includes a transmitter 32, operable to transmit data from the sensor system 30, wired or wirelessly. for further processing. In certain configurations, a wired and wireless combination is employed, with a wire a certain distance from the subject, measured conductor 14 to the wireless transmitter in order to minimize interference. Wireless transmission may can use those known in the art such as AM, FM, analog, digital, or other known transmission formats. Additionally, the transmitter 32 may employ spectrum and/or communication protocols such as Bluetooth, Zigbee, Low-Power Wide-Area Network, WiFi, and others known in the art.

In certain communications, communication of the transmitted sensor system 30 data is further facilitated by a network 24. Network 24 may also include one or more wide area networks (WANs), local area networks (LANs), personal area networks (PANs), mesh networks, all or a portion of the Internet, and/or any other communication system or systems at one or more locations. Further, all or a portion of network 24 may comprise either a wireline or wireless link. In other words, network 24 encompasses any internal or external network, networks, sub-network, or combination thereof operable to facilitate communications between various computing components inside and outside the illustrated environment. The network 24 may communicate, for example, Bluetooth, Zigbee, Internet Protocol (IP) packets, Frame Relay frames, Asynchronous Transfer Mode (ATM) cells, voice, video, data, and other suitable information between network addresses.

In certain configurations, a computer 42 receives the sensor system 30 data for further processing. A computer or server, generally refers to a system which includes a processor, memory, a screen, a network interface, storage, and input/output (I/O) components connected by way of a data bus. The I/O components may include for example, a mouse, keyboard, buttons, or a touchscreen. A server contains various server software programs and preferably contains application server software. Those skilled in the art will appreciate that the computer or servers can take a variety of configurations, including personal computers, hand-held devices, multi-processor systems, microprocessor-based electronics, network PCs, minicomputers, mainframe computers, and the like. Additionally, the computer may be part of a distributed computer environment where tasks are performed by local and remote processing devices that are communicatively linked. One skilled in the art can understand that the structure of and functionality associated with the aforementioned elements can be optionally partially or completely incorporated within one or the other, such as within one or more processors.

Certain configurations of the system include specialized storage in the form of a database 44 configured to store sensor system 30 and other data. In exemplary configuration, sensor system 30 data is received for storage and processing. The sensor system 30 data may be instantaneous values, average values, a series of values, vectors representing values, waveforms, or other types known in the art. One skilled in the art would appreciated that the data may reside in one or more databases, tables, or computers. Representative suitable database systems include text, Excel, SQL, noSQL, or other formats known in the art.

Having describe major elements of an embodiment of a system, a process of use is described. At step 110, baseline values are established. At step 120, electronic equipment is deployed. At step 130, sensor systems are coupled to the conductors. At step 140, the conductors are monitored. At step 150, the sensor system data is compared to the baseline. More consideration will be given to each of the steps below.

At step 110, threshold values are established. Threshold values for the target property are determined. For example, certain resistance, current flow, surrounding radio frequency and magnetic flux 16, and/or other properties are determined. The threshold(s) can be single values (representing an instantaneous values), average value (weighted or otherwise), curve or vector, or a waveform.

Threshold values may be determination by reference, change over time, experimentation, learning, and/or other means known in the art. The values may be adjusted for the operating environment. To illustrate, the wire 14 may be expected to be deployed in a certain high voltage, high current alternating current environment. In determining threshold values, threshold flux value(s) might be adjusted by the voltage, current, wire length, wire orientation, wire gauge, and other operating parameters.

For example, in determination of a threshold by reference, if the wires 14 are of a common gauge, expected to operate at a common voltage and current, and is in a linear orientation, the expected flux value may be retrieved by reference and a threshold set proportional to that value.

For example, in determination of a threshold by historical changes, periodic readings of the subject measurement are taken. The threshold is set based on deviation from one or more of the historical readings.

the target if the wires 14 are of a common gauge, expected to operate at a common voltage and current, and is in a linear orientation, the expected flux value may be retrieved by reference and a threshold set proportional to that value.

For example, in determination of a threshold by experimentation, corroded wires 14 of a known gauge, are operated at a known voltage and current, and in a known orientation, the flux value is measured a threshold set based on that value.

For example, in determination by learning, machine learning may employed. One or more training datasets are created by measuring the properties of wires 14 in various states of corrosion and the target measured property, such as magnetic flux. In certain configurations, a sample dataset is employed for corroded wire 14 recognition by machine learning. In certain configurations, a sample dataset is employed for corrosion probability recognition.

In one approach, nearest neighbour classifiers such as the k-nearest neighbors algorithm are used to compare wire 14 transmission properties with stored features and a nearest threshold match is made. A reference classifier wire dataset is input to the system. In certain configurations, a wire properties dataset from the sensor systems 30 to be deployed in the environment is input into the system.

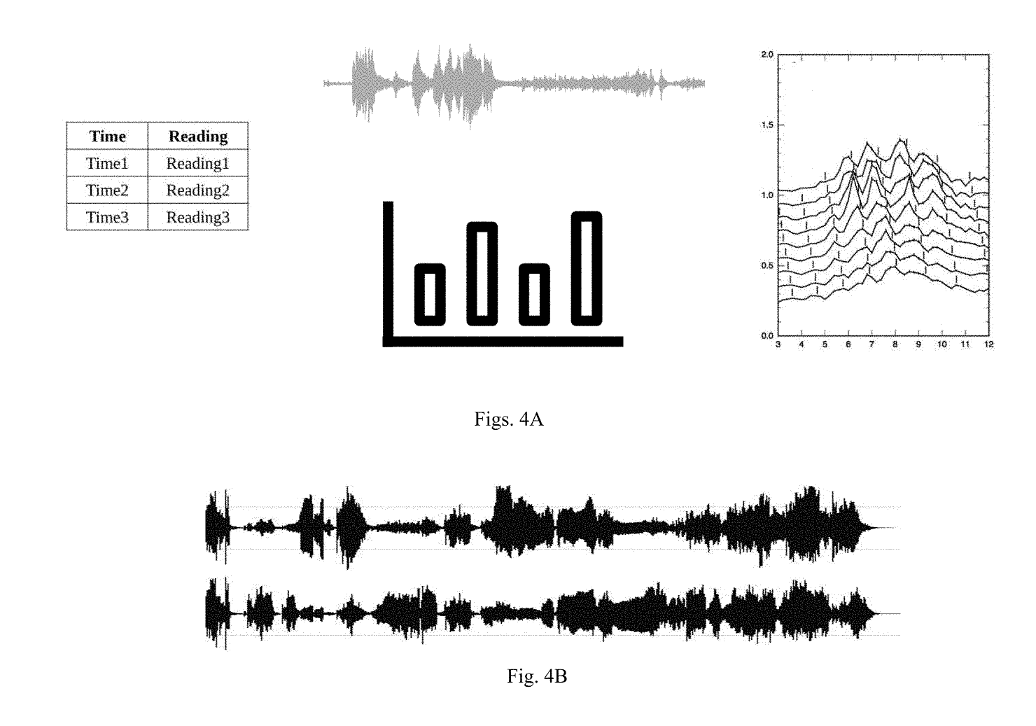

At step 120, the electronic equipment is deployed to the target environment. A connector 12 is selected (FIGS. 2A and 2B). At step 130, the sensor system 30 is securely coupled to the wire 14 at the set position (FIGS. 3A and 3D). Power is provided to the sensor system 30 and the transmitter 32 is activated. At step 140, the wire 14 is monitored, with the sensor system 30 providing readings (FIG. 4A), which are transmitted 32 over the network 24 to a server for storage in the database 44 and processing (FIG. 1).

At step 150, the received values are compared against the threshold values (FIG. 4B). The system compares the monitored values against the threshold values by raw value comparison, against averages (average, weighted, moving, or otherwise). Where the values are out of the threshold range, an alert is generated for further inspection.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for corrosion monitoring, said system comprising:
a conductor, an electrical connector, a sensor system, a transmitter, a network, and a computer having a database;
the conductor being one or more current carrying conductors inline with and having a connector at each end such that there is electrical communication between the connectors; the sensor system is configured for attachment to the conductor, and is operable to measure one or more of resistance, temperature, current flow, surrounding radio frequency and/or magnetic flux;
the transmitter coupled the sensor system, operable to transmit data from the sensor system over the network to a processor for further processing;
the computer includes a database for storage of sensor system in the form of instantaneous values, average values, a series of values, vectors representing values, or waveforms; and
the computer, in communication with the database, receiving and storing threshold sensor systems data;
the computer, in communication with the database, receiving periodic sensor systems data, comparing it against the threshold, and generating an alert on out of threshold conditions.
